(19) United States
(12) Patent Application Publication
(10) Pub. No.: US 2025/0054993 A1
(43) Pub. Date: Feb. 13, 2025

(54) BLENDED ANODE FOR LITHIUM-ION BATTERIES

(71) Applicant: Apple Inc., Cupertino, CA (US)

(72) Inventors: Xin Zhao, San Jose, CA (US); Karthikeyan Kumaresan, Sunnyvale, CA (US); Shabab Amiruddin, Pacifica, CA (US); Libo Hu, Mountain View, CA (US); Qiuyan Li, Cupertino, CA (US)

(21) Appl. No.: 18/798,661

(22) Filed: Aug. 8, 2024

Related U.S. Application Data
(60) Provisional application No. 63/519,192, filed on Aug. 11, 2023.

(51) Int. Cl. H01M 4/66; H01M 4/02; H01M 4/04; H01M 4/36; H01M 4/525; H01M 4/583; H01M 10/0525

(52) U.S. Cl. CPC H01M 4/661; H01M 4/0404; H01M 4/364; H01M 4/525; H01M 4/583; H01M 4/666; H01M 10/0525; H01M 2004/027; H01M 2004/028

(57) ABSTRACT

The disclosure is directed to blended anode materials including at least two types of electrochemically active components possessing different redox potentials. The anode design renders improved chemical and structural stability to that of the conventional single-phase graphite anode particularly at high and/or low electrochemical potentials.

### PRIORITY

This patent application claims the benefit of U.S. Provisional Patent Application No. 63/519,192, entitled “BLENDED ANODE FOR LITHIUM-ION BATTERIES,” filed on Aug. 11, 2023, which is incorporated herein by reference in its entirety.

### FIELD

This disclosure relates generally to batteries, and more particularly, to anode active materials for lithium-ion batteries.

### BACKGROUND

High-performance lithium-ion batteries are used to address the ever-increasing energy demands and environmental challenges.

Energy density, which is one of the main characteristics of batteries, is a function of the deliverable capacity and operating voltage. Improving the energy density often can include (1) maximizing the difference of electrochemical potentials of the cathode and anode (i.e., raising the upper cutoff voltage (Vmax) that the batteries can be charged to), (2) increasing the electrochemical stability window of the electrolyte components to limit deleterious reductive and oxidative reactions of the liquid electrolyte and salt; and (3) reducing the mass and volume of active materials per exchanged electron.

Layered lithium transition metal oxides (LiₓM_{y}O_{z}, M=transition metal element, e.g., Ni, Mn, Co . . . ) typically have compact structures and consequentially high packing densities, high specific volumetric capacity, stable charge/discharge voltages and comparatively good cyclability. Improvements to operating batteries at high voltage is particularly desirable.

### SUMMARY

In one aspect, the disclosure is directed to a battery cell including a cathode having a cathode active material disposed on a cathode current collector and an anode including a blended anode active material disposed on an anode current collector. The blended anode active material includes a first anode active constituent and a second anode active constituent having a lower redox potential than the first anode active constituent.

In some variations, the anode has a lower anode potential than a single-phase anode with only the first anode active constituent and no second anode active constituent.

In some variations, battery cell has less electrolyte degradation as a function of cycle count or calendar lifetime than a battery cell comprising only the first anode active constituent and no second anode active constituent.

In some variations, the battery cell has less solid electrolyte interphase (SEI) degradation as a function of cycle count than a battery cell comprising only the first anode active constituent and no second anode active constituent.

In some variations, the cathode has a lower potential than a cathode in a battery cell comprising the anode comprising only the first anode active constituent and no second anode active constituent.

In some variations, the cathode active material has less degradation as a function of cycle count or calendar lifetime than the battery cell comprising only the first anode active constituent and no second anode active constituent.

In a second aspect, the amount of first anode constituent and second anode constituent can be in different amounts. In one variation, the mass ratio of the second to the first anode active constituent is in the range of 1:200 to 200:1.

In some variations, the first anode active constituent is selected from graphite and an intermetallic alloy-based material. In further variations, the intermetallic alloy-based material is selected from silicon, tin, a lithium silicon alloys, and a lithium tin alloy. In still further variations, the first anode constituent is graphite. In still further variations, the first anode active constituent is an ordered matrix.

In some variations, the second anode active constituent is selected from disordered graphitic carbon, non-graphitic carbon, and a nanostructured carbon material. In further variations, the second anode active constituent is a non-graphitic carbon selected from a hard carbon and a microporous/mesoporous carbon. In further variations, the second anode active constituent is hard carbon. In additional variations, the nanostructured carbon material selected from carbon nanotubes, graphene flakes, and reduced graphene oxide.

In some variations, the cathode current collector is aluminum foil. In additional variations, the anode current collector is copper foil.

In some variations, the cathode active material is a lithium transition metal oxide. In further variations, the lithium transition metal oxide is a compound of Formula (I):

LiₐCo_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof;
0.95≤a≤1.05;
0<b≤0.50; and
1.95c≤2.05.

In some variations, Me is a single element selected from Na, Si, S, Al, K, V, Cr, Fe, Cu, Zn, Mn, Ni, Zr, La, Ce, Y, Mo, Sn, Ag, Nb, Nu, Ca, Ti, and Mg, then 0<b≤0.15.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a side view of a set of layers for a battery cell, in accordance with an illustrative embodiment;

FIG. 3A depicts the potential profiles of a cathode and an anode, and the corresponding full-cell voltage profile during charge cycles, in accordance with an illustrative embodiment;

FIG. 3B depicts the relative shift of the potential profiles of the cathode and the single-phase anode before and after cycling and the corresponding full-cell voltage profile near the end of charge, in accordance with an illustrative embodiment;

FIG. 3C depicts the relative shift of the potential profiles of the cathode and the blended anode before and after cycling and the corresponding full-cell voltage profile near the end of charge, in accordance with an illustrative embodiment;

FIG. 4A depicts the electrochemical potential of a single-phase anode coupled to a cathode as compared to a blended anode coupled to the cathode, in accordance with an illustrative embodiment;

FIG. 4B depicts the effect of the anode potential on the corresponding cathode potential, in accordance with an illustrative embodiment;

FIG. 5A depicts the low voltage effect of a single-phase anode as compared to a blended anode, in accordance with an illustrative embodiment;

FIG. 5B depicts a shift in lower cutoff potential for a single-phase anode as compared to a blended anode, in accordance with an illustrative embodiment; and

FIG. 6 depicts the 0.2 C energy retention normalized to minimum rated design value cycled at 45° C. for a battery having a control anode with 100% graphite and a battery with an anode design including 1% hard carbon blended with the control graphite, according to an illustrative embodiment.

### DETAILED DESCRIPTION

The following description is presented to allow any person skilled in the art to make and use the embodiments, and is provided in the context of a particular application. Various modifications to the disclosed embodiments will be readily apparent to those skilled in the art, and the general principles defined herein may be applied to other embodiments and applications without departing from the spirit and scope of the present disclosure. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Thus, the disclosure is not limited to the embodiments shown, but is to be accorded the widest scope consistent with the principles and features disclosed herein.

As used herein, all compositions referenced for cathode active materials represent those of as-prepared materials (i.e., “virgin” materials) unless otherwise indicated. Materials of these compositions have not yet been exposed to additional processes, such as de-lithiation and lithiation during, respectively, charging and discharging of a lithium-ion battery.

The disclosure is directed to blended anode active materials including at least two types of electrochemically active components possessing different redox potentials. A blended anode design, which incorporates blended anode active material, can confer a number of advantageous characteristics to a battery. This includes improved chemical and structural stability as compared to a conventional single-phase graphite anode, particularly at high and/or low electrochemical potentials. When coupled with a cathode, the selection of the first and second anode constituents based on the difference in their redox potential blended anode to tune the electrochemical window of the cathode. Such selection, or tuning, can improve energy density and/or longevity of the battery compared to the conventional single-phase anode batteries.

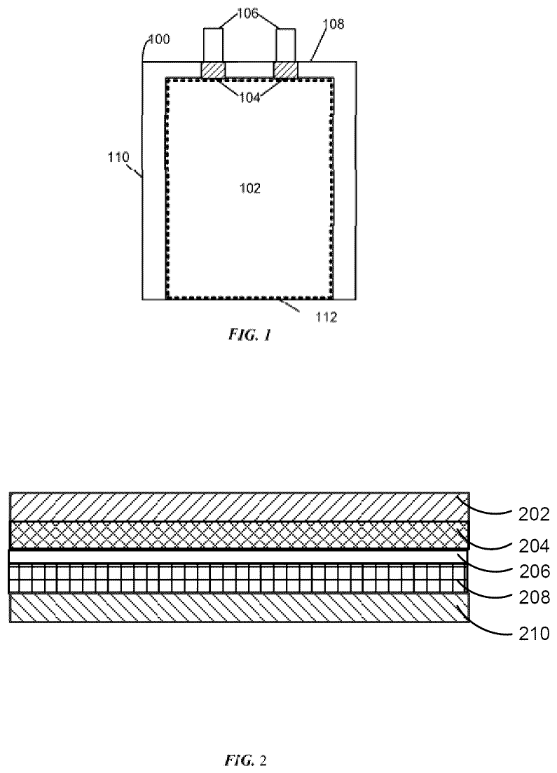

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode, a separator, and an anode. The stack 102 also includes a separator disposed between the cathode and anode. The cathode, anode, and separator layers may be left flat in a planar configuration or may be wrapped into a wound configuration (e.g., a “jelly roll”).

Battery cells can be enclosed, for example in a flexible pouch or a hard case. Returning to FIG. 1, during assembly of the battery cell 100, the stack 102 can be enclosed in a pouch. The pouch can be flexible or rigid. The stack 102 may be in a planar or wound configuration, although other configurations are possible. If flexible, the pouch can be formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a terrace seal 108. In some variations, the flexible pouch may be less than 120 microns thick to improve the packaging efficiency of the battery cell 100, the density of battery cell 100, or both.

The stack 102 also includes a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack.

Batteries can be combined in a battery pack in any configuration. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

FIG. 2 presents a side view of a set of layers for a battery cell (e.g., the battery cell 100 of FIG. 1) in accordance with the disclosed embodiments. The set of layers may include a cathode current collector 202, a cathode active material 204, a separator 206, an anode active material 208, and an anode current collector 210. The cathode current collector 202 and the cathode active material 204 form a cathode for the battery cell, and the anode current collector 210 and the anode active material 208 form an anode for the battery cell. To create the battery cell, the set of layers may be stacked in a planar configuration, or stacked and then wrapped into a wound configuration.

As mentioned above, the cathode current collector 202 may be aluminum foil, the cathode active material 204 may be a lithium transition metal oxide compound, the anode current collector 210 may be copper foil, and the separator 206 may include a conducting polymer electrolyte.

It will be understood that the cathode active materials described herein can be used in conjunction with any battery cells or components thereof known in the art. For example, in addition to wound battery cells, the layers may be stacked and/or used to form other types of battery cell structures, such as bi-cell structures. All such battery cell structures are known in the art.

At higher-voltage applications, the longevity of the full battery cells is fundamentally challenged by the meta-stable nature of the electrochemical processes. On one hand, the cathode active materials undergo irreversible structural changes due to fatigue cycling from lattice strains developed during Li-ion intercalation/de-intercalation, as well as more intense parasitic reactions between the cathode surface and electrolyte. On the other hand, the parasitic reactions between the anode active materials and electrolyte are also accelerated with the anode being charged to lower electrochemical potentials, which consume the available Li ions for charge/discharge and lead to irreversible capacity loss.

Any cathode active material known in the art can be used in compositions, battery cells, and methods described herein.

In some variations, the cathode active material is a layered lithium transition metal oxide (LiₓM_{y}O_{z}, M=transition metal element, e.g., Ni, Mn, Co . . . ). Layered lithium transition metal oxides can have compact structures and consequentially high packing densities, high specific volumetric capacity, stable charge/discharge voltages and comparatively good cyclability.

In some further variations, cathode active material includes a compound represented by Formula (I):

LiₐCo_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof;
0.95≤a≤1.05;
0<b≤0.50; and
1.95≤c≤2.05.

In some variations, where Me is a single element selected from Na, Si, S, Al, K, V, Cr, Fe, Cu, Zn, Mn, Ni, Zr, La, Ce, Y, Mo, Sn, Ag, Nb, Nu, Ca, Ti, and Mg, then 0<b≤0.15.

In further variations, Me is more than one element and each separate element present in b is less than or equal to 0.10.

In still further variations, Me is selected from Al, Mn, Ni, Zr, La, Ce, Y, Mo, Sn, Ag, Nb, Ca, Ti, and Mg. The amounts of any element or elements of Me, or selected groups of Me, can be combined with the amount of each element or elements in any combination described herein.

The compound can be any compound described in PCT US2017/052436 or PCT/US2017/022320, both of which are incorporated herein by reference in their entirety.

The disclosure is directed to blended anode active materials including at least a first anode active constituent and second anode active constituents with different redox potentials.

The blended anode can confer one or more advantages to battery cells. The blended anode can confer improved chemical and structural stability to that of the conventional single-phase anode (e.g., graphite anode), particularly at high and/or low electrochemical potentials. The constituents of the blended anode active material can have different electrochemical redox potentials, and can be charged/discharged individually, depending on their specific redox potentials. When coupled with a cathode system, the blended anode can be used to tune the electrochemical window of the cathode, to improve energy density and/or longevity, compared to the conventional single-phase anode batteries.

The blended anode active material includes at least two types of active constituents. In general, the first anode active constituent has a higher anode potential than the second anode active constituent. In some variations, the first anode constituent can be graphite or an intermetallic alloy-based material. Examples of intermetallic alloy-based material can be silicon, tin, a lithium silicon alloys, a lithium tin alloy. In variations, the first anode active constituents serves as an ordered “matrix” into which the second anode active constituent can be placed. In some variations, the first anode constituent is graphite.

The blended anode active material includes a second anode active constituent that exhibits a lower redox potential than that of the first anode active constituent. In variations, the second anode active constituent can be selected from disordered graphitic carbon, non-graphitic carbon, and nanostructured carbon materials. Non-limiting examples of non-graphitic carbon include hard carbon or other microporous/mesoporous carbon. Non-limiting examples of nanostructured carbon materials include carbon nanotubes, graphene flakes, and reduced graphene oxide. In some variations, the second anode active material is hard carbon. The second anode active constituent can be considered an “additive.” In various aspects, the second anode active constituent included has a different crystallinity (e.g., a smaller size of graphitic domains or a larger interlayer distance) relative to graphite, and can be considered “disordered” as compared to the first anode active constituent.

In some variations, the mass ratio of the first anode active constituent to the second anode active constituent is in the range of 1:200 to 200:1.

In some variations, the mass ratio of the first anode active constituent to the second anode active constituent is greater than or equal to or equal to 1:200. In some variations, the mass ratio of the first anode active constituent to the second anode active constituent is greater than or equal to 1:180. In some variations, the mass ratio of the first anode active constituent to the second anode active constituent is greater than or equal to 1:160. In some variations, the mass ratio of the first anode active constituent to the second anode active constituent is greater than or equal to 1:140. In some variations, the mass ratio of the first anode active constituent to the second anode active constituent is greater than or equal to 1:120. In some variations, the mass ratio of the first anode active constituent to the second anode active constituent is greater than or equal to 1:100. In some variations, the mass ratio of the first anode active constituent to the second anode active constituent is greater than or equal to 1:80. In some variations, the mass ratio of the first anode active constituent to the second anode active constituent is greater than or equal to 1:60. In some variations, the mass ratio of the first anode active constituent to the second anode active constituent is greater than or equal to 1:40. In some variations, the mass ratio of the first anode active constituent to the second anode active constituent is greater than or equal to 1:20. In some variations, the mass ratio of the first anode active constituent to the second anode active constituent is greater than or equal to 1:1.

In some variations, the mass ratio of the first anode active constituent to the second anode active constituent is greater than or equal to 20:1. In some variations, the mass ratio of the first anode active constituent to the second anode active constituent is greater than or equal to 40:1. In some variations, the mass ratio of the first anode active constituent to the second anode active constituent is greater than or equal to 60:1. In some variations, the mass ratio of the first anode active constituent to the second anode active constituent is greater than or equal to 80:1. In some variations, the mass ratio of the first anode active constituent to the second anode active constituent is greater than or equal to 100:1. In some variations, the mass ratio of the first anode active constituent to the second anode active constituent is greater than or equal to 120:1. In some variations, the mass ratio of the first anode active constituent to the second anode active constituent is greater than or equal to 140:1. In some variations, the mass ratio of the first anode active constituent to the second anode active constituent is greater than or equal to 160:1. In some variations, the mass ratio of the first anode active constituent to the second anode active constituent is greater than or equal to 180:1.

In some variations, the mass ratio of the first anode to the second anode is less than or equal to 200:1. In some variations, the mass ratio of the first anode to the second anode is less than or equal to 180:1. In some variations, the mass ratio of the first anode to the second anode is less than or equal to 160:1. In some variations, the mass ratio of the first anode to the second anode is less than or equal to 140:1. In some variations, the mass ratio of the first anode to the second anode is less than or equal to 120:1. In some variations, the mass ratio of the first anode to the second anode is less than or equal to 100:1. In some variations, the mass ratio of the first anode to the second anode is less than or equal to 80:1. In some variations, the mass ratio of the first anode to the second anode is less than or equal to 60:1. In some variations, the mass ratio of the first anode to the second anode is less than or equal to 40:1. In some variations, the mass ratio of the first anode to the second anode is less than or equal to 20:1. In some variations, the mass ratio of the first anode to the second anode is less than or equal to 1:1.

In some variations, the mass ratio of the first anode to the second anode is less than or equal to 1:20. In some variations, the mass ratio of the first anode to the second anode is less than or equal to 1:40. In some variations, the mass ratio of the first anode to the second anode is less than or equal to 1:60. In some variations, the mass ratio of the first anode to the second anode is less than or equal to 1:80. In some variations, the mass ratio of the first anode to the second anode is less than or equal to 1:100. In some variations, the mass ratio of the first anode to the second anode is less than or equal to 1:120. In some variations, the mass ratio of the first anode to the second anode is less than or equal to 1:140. In some variations, the mass ratio of the first anode to the second anode is less than or equal to 1:160. In some variations, the mass ratio of the first anode to the second anode is less than or equal to 1:180.

The upper and lower limits of the mass ratio of the first anode to the second anode can be selected in any combination. For example, in some non-limiting examples of graphite and hard carbon blended anode, the mass ratio of hard carbon to graphite is typically in the range from 1:200 to 1:1.

In conventional single-phase graphite anodes, irreversible capacity loss from the consumption of Li-ion inventory at the anode can cause its potential profile to shift relative to the cathode potential profile. This shift is reduced in the blended anode.

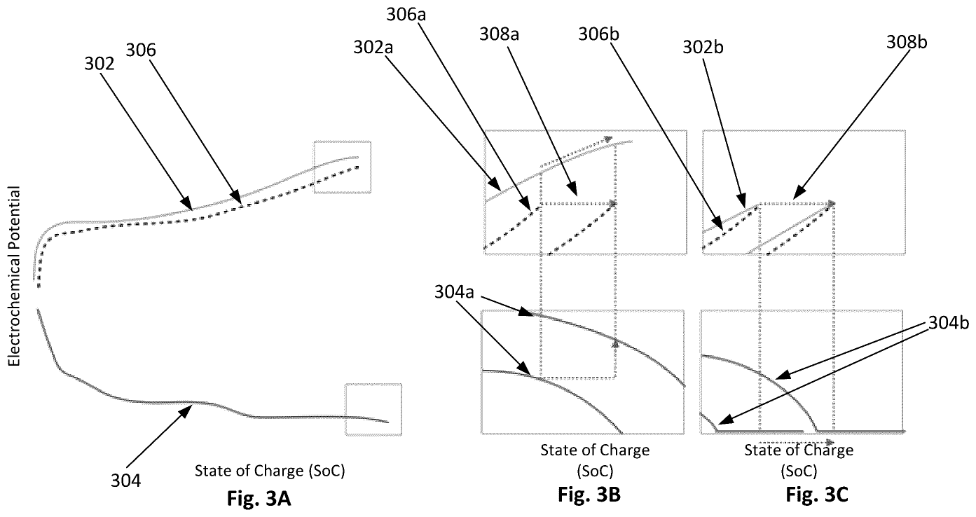

FIG. 3A depicts the relative shift in electrode potential profiles of a cathode 302 and an anode 304, along with the corresponding full-cell voltage profile during charge cycles 306. With respect to FIG. 3B, potential profiles as a function of state of charge (SoC) of transition metal cathode 302a and a graphite anode 304a, along with the full-cell voltage 306a are depicted at the end of charge when the full-cell voltage approaches Vmax 308a. Vmax 308a refers to the upper cutoff voltage. As the Li ions and electrons are irreversibly consumed at the anode, the anode SoC 304a reduces gradually, accompanied by a rise of anode potential at the end of charge. To compensate the Li-ion and electron loss and to maintain the Vmax 308a constant, additional cathode capacity is accessed, which yields a simultaneous increase of cathode potential 302a. The increase in cathode potential 302a causes cathode “overcharging” during cycling. The “sloped” potential profiles of both the cathode 302a and anode 304a results in both degradation of the cathode and electrolyte oxidation at the cathode surface.

The longevity of the batteries towards low-voltage discharge is constrained by the stability of the anode/electrolyte interface. With further reference to FIG. 3A, toward the end of discharge when all the Li ions are extracted from the graphite anode active material, the full-cell voltage profile becomes steeply sloped as the anode polarizes to high potentials. The solid electrolyte interphase (SEI) (not shown) formed on the anode is prone to mechanical cracking arising from anode contraction at lower SoC. The re-exposed anode surface can promote further electrolyte decomposition, which also depletes the Li-ion inventory over cycling and reduces the lifespan of the batteries.

With further reference to FIG. 3B the potential profiles of a cathode 302a and anode 304a, and the corresponding full-cell voltage 306a profile during charge cycles. The anode potential curve 304a shifts to the right. The cathode potential curve 302a also increases to maintain the full cell voltage 306a at constant Vmax 308a. The increase in the cathode potential results in more access of cathode capacity and thus degradation of the cathode.

FIG. 3C depicts the relative shift of the potential profiles of the cathode 302b and the blended anode 304b before and after cycling. The anode potential curve 304b shifts to the right, while the end-of-charge anode potential remains unchanged because of the additional lower-potential plateau. The cathode potential curve 302b therefore maintains the same shape without upshifting, to maintain the full cell voltage 306b at constant Vmax 308b.

The higher the cathode potential, the faster cathode degradation occurs. Further, electrolyte consumption is accelerated, reducing the SEI at the anode. If the cathode potential is at a lower value at the same battery cell voltage, the cathode degradation and electrolyte consumption occur more slowly, resulting in longer battery life.

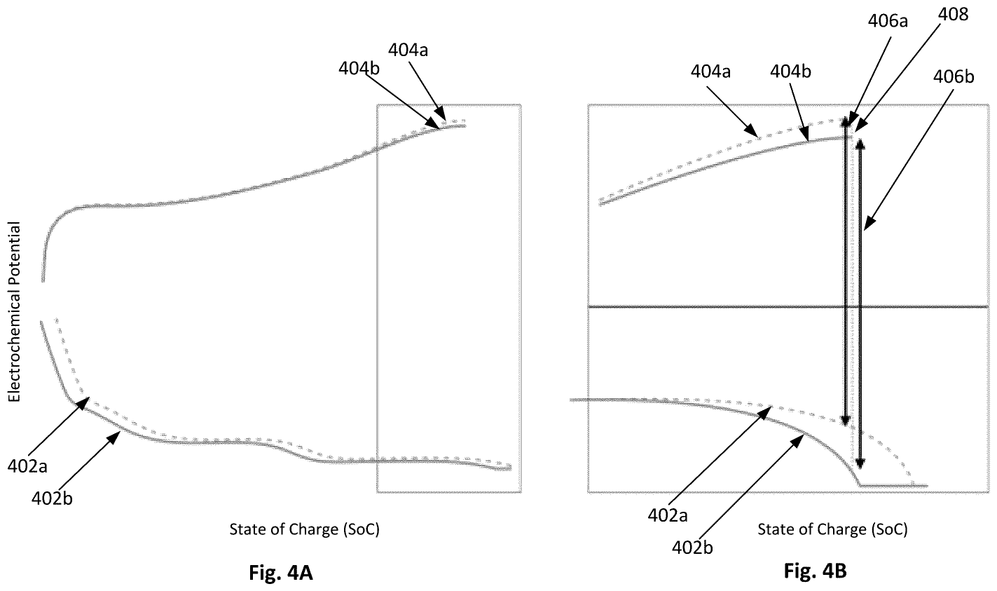

FIG. 4A depicts the electrochemical potential of a single-phase anode 402a coupled with a cathode 404a as compared to a blended anode 402b coupled to the cathode 404b.

FIG. 4B depicts the net effect on the anode potential (402a, 402b) and the corresponding cathode potential (404a, 404b) near the end of charge. The Vmax (406a, 406b) is fixed in both the single-phase anode potential 402a and blended anode potential 402b. The batteries are charged to the state of charge where the battery cell is fully charged 408. The blended anode potential reduces close to zero. With a constant Vmax (406a, 406b), the blended anode potential 402b has a lower potential than the single-phase anode potential 402a, resulting in a lower cathode potential 404b compared to 404a.

The second anode component (e.g., hard carbon) has a redox potential lower than that of graphite. Further, lithium does not readily plate in disordered second anode components such as hard carbon, unlike pure graphite. The lower-plateau capacity of the second anode component results in simultaneously decreased anode and cathode potentials relative to the single-phase graphite anode design. This improves the lifecycle of the battery cell.

By way of example and not limitation, if the first anode component is graphite and the second anode component is hard carbon, lithiation of graphite typically renders a potential plateau at 50-85 mV (vs. Li/Li⁺) when passing through the last stage of graphite phase transition (LiC₁₂ to LiC₆). Overlithiating graphite to beyond this biphasic region induces lithium-metal nucleation reactions and intensive electrolyte reduction. In contrast, hard carbon exhibits long-range plateau capacities at ˜0 V (vs. Li/Li⁺), attributed to lithium nanocluster formation within the inner pores of hard carbon. Therefore, this discrepancy of anode potentials near the fully charged states offsets the cathode potential by 50-85 mV, which effectively reduces the cathode SoC.

From a dynamic point of view, the risk of cathode overcharging during repetitive charge and discharge is also mitigated by implementing the blended anode. When sufficient amount of the second anode component, such as hard carbon, is blended into the first anode component, such as graphite, the anode remains in the “flat” potential regime at the end of charge, even when the loss of Li-ion inventory occurs. This allows the cathode potential to remain unchanged during over-cycling, as shown in FIG. 3C, which alleviates cathode degradation exacerbated by the upshift of cathode potential.

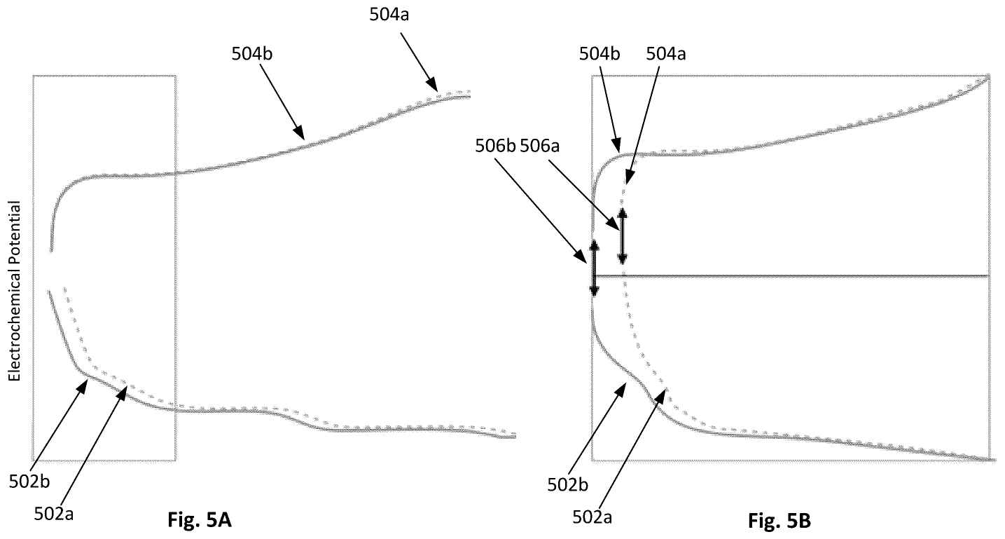

The blended anode also benefits the low-voltage applications by modifying the electrode potential profiles near the end of discharge, in contrast to a single-phase anode. As shown in FIG. 5A, the capacity of full cells with the single-phase anode 502a is largely limited by the capacity of anode, primarily attributed to a sharper turn-up in the potential profile of the anode, compared to that of the cathode 504a. With the rapid rise of anode potential, the graphite undergoes a non-uniform volume change and SEI dissolution. This results in more lithium consumption on the anode side, which negatively affects stability. In contrast, the capacity of full cells using the blended anode 502b can be more limited by the cathode 504b, as the Li ions in the blended anode 502b are exhausted less rapidly. With respect to FIG. 5B, this manifests as simultaneously decreased anode and cathode potentials at the end of discharge, to maintain the full-cell voltage constant (i.e., constant lower cutoff voltage 506b, as compared to 506a). The SEI degradation posed by the volume variation of the “deeply discharged” anode is thus circumvented effectively. When the anode potential profile shifts to the right due to the loss of Li ion inventory, the growth of the anode end-of-discharge potential is less detrimental, because of the delayed Li ion exhaustion of the blended anode.

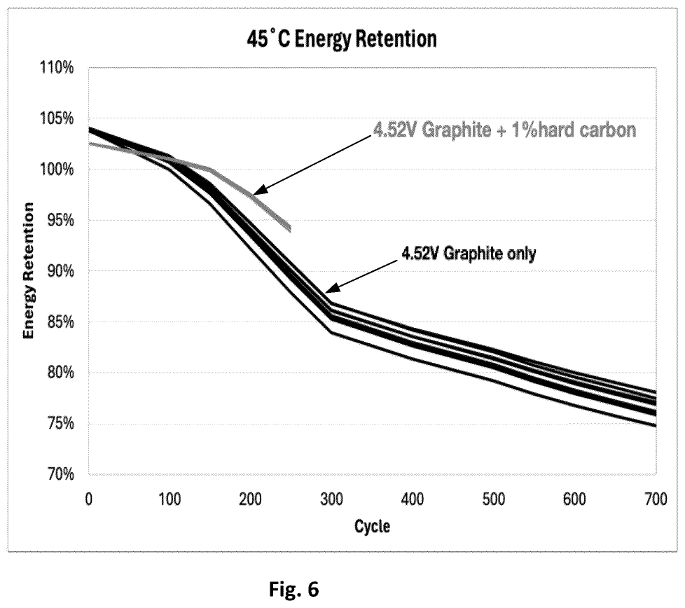

FIG. 6 shows the 0.2 C energy retention normalized to min rated design value cycled at 45° C., for a battery having a control anode with 100% graphite and a battery with an anode design including 1% hard carbon blended with the control graphite. The energy retention shows significantly better result at 250 cycles with 5% improvement over the baseline, and overcomes the fast energy fading behavior with the 4.52V high operation voltage of the battery.

The anodes, battery cells, and other materials described herein can be valuable in any battery containing device, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A battery cell comprising:
a cathode and an anode;
the cathode comprising a cathode active material disposed on a cathode current collector; and
the anode comprising a blended anode active material disposed on an anode current collector;
the blended anode active material comprising a first anode active constituent and a second anode active constituent having a lower redox potential than the first anode active constituent.

2. The battery cell of claim 1, wherein the anode has a lower potential than a single-phase anode consisting of only the first anode active constituent.

3. The battery cell of claim 1, wherein the battery cell has less electrolyte degradation as a function of cycle count or calendar lifetime than a battery comprising an anode consisting of only the first anode active constituent.

4. The battery cell of claim 1, wherein the battery cell has less solid electrolyte interphase (SEI) degradation as a function of cycle count than a battery comprising an anode consisting of only the first anode active constituent.

5. The battery cell of—claim 2, wherein the cathode has a lower potential than a cathode in a battery comprising an anode consisting of only the first anode active constituent.

6. The battery cell of claim 5, wherein the cathode active material has less degradation as a function of cycle count or calendar lifetime than the battery comprising an anode consisting of only the first anode active constituent.

7. The battery cell of claim 1, wherein ratio of the mass of the first anode active constituent to the mass of the second anode active constituent is from 1:200 to 200:1.

8. The battery cell of claim 7,
wherein the first anode active constituent is graphite and the second anode active constituent is hard carbon, and
wherein the mass ratio of the first anode active constituent to the second anode active constituent is 1:200 to 1:1.

9. The battery cell of claim 1, wherein the first anode active constituent is selected from graphite and an intermetallic alloy-based material.

10. The battery cell of claim 9, wherein the first anode active constituent is an intermetallic alloy-based material selected from silicon, tin, a lithium silicon alloys, and a lithium tin alloy.

11. The battery cell of claim 9, wherein the first anode constituent is graphite.

12. The battery cell of claim 1, wherein the first anode active constituent is an ordered matrix.

13. The battery cell of claim 1, wherein the second anode active constituent is selected from disordered graphitic carbon, non-graphitic carbon, and a nanostructured carbon material.

14. The battery cell of claim 13, wherein the second anode active constituent is a non-graphitic carbon selected from a hard carbon and a microporous/mesoporous carbon.

15. The battery cell of claim 14, wherein the second anode active constituent is hard carbon.

16. The battery cell of claim 13, wherein the second anode active constituent is a nanostructured carbon material selected from carbon nanotubes, graphene flakes, and reduced graphene oxide.

17. The battery cell of claim 1, wherein the cathode current collector is aluminum foil.

18. The battery cell of claim 1, wherein the anode current collector is copper foil.

19. The battery cell of claim 1, wherein the cathode active material comprises a lithium transition metal oxide.

20. The battery cell of claim 19, wherein the lithium transition metal oxide is a compound of Formula (I):
LiₐCo_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof;
0.95≤a≤1.05;
0<b≤0.50; and
1.95≤c≤2.05.

21. The battery cell of claim 20, wherein Me is a single element selected from Na, Si, S, Al, K, V, Cr, Fe, Cu, Zn, Mn, Ni, Zr, La, Ce, Y, Mo, Sn, Ag, Nb, Nu, Ca, Ti, and Mg, then 0<b≤0.15.
